(19) United States
(12) Patent Application Publication
(10) Pub. No.: US 2025/0211821 A1
(43) Pub. Date: Jun. 26, 2025

(54) SYSTEM AND METHOD FOR INTERACTIVE WEB-BROWSING VIA USER EQUIPMENT

(71) Applicant: HYTTO PTE. LTD., Singapore (SG)

(72) Inventors: Dan LIU, Guangzhou (CN); Jilin QIU, Guangzhou (CN); Meiwei YIN, Guangzhou (CN)

(73) Assignee: HYTTO PTE. LTD., Singapore (SG)

(21) Appl. No.: 19/079,436

(22) Filed: Mar. 13, 2025

Related U.S. Application Data
(63) Continuation-in-part of application No. 18/541,008, filed on Dec. 15, 2023, now Pat. No. 12,256,131.
Application No. 18/541,008 is a division of application No. 18/048,817, filed on Oct. 21, 2022, now Pat. No. 11,943,516.

(51) Int. Cl. H04N 21/431; H04N 21/2187; H04N 21/4782

(52) U.S. Cl. CPC H04N 21/4316; H04N 21/2187; H04N 21/4782

(57) ABSTRACT

A method for participating in an interactive broadcast, performed by a first viewer device. The method includes running a first application on the first viewer device, accessing, via the first application, online entertainment data associated with an online platform, and in response to trigger data received by the first application, generating a first instruction to control an operation of an interactive element based on the triggered data. The online entertainment data is accessible by at least one of: a second viewer device configured not to run the first application, or a third viewer device configured to run the first application. The first application is configured to initiate the operation of the interactive element. The operation of the interactive element is observable to at least one of the first viewer device or the third viewer device, but not observable to second viewer device.

### CROSS-REFERENCE TO RELATED APPLICATIONS

The present application is a continuation-in-part application of U.S. patent application Ser. No. 18/541,008, filed on Dec. 15, 2023, which is a divisional application of U.S. patent application Ser. No. 18/048,817 (issued as U.S. Pat. No. 11,943,516), filed on Oct. 21, 2022. The entire contents of the above patent documents are hereby incorporated by reference herein.

### TECHNICAL FIELD

The present disclosure relates to web browsing and, more specifically, to a system and method for interactive web-browsing via user equipment.

### DISCUSSION OF THE RELATED ART

Recently, users have been able to view live-streamed broadcasts and events over the Internet using a web browser running on a device such as a computer or smartphone. While in some instances, users might only be able to view the broadcast or event, in other instances, users are able to interact with the broadcast by participating in a live broadcast room website where multiple users may be able to view the live stream and chat in real-time with the content creators and other users. Users may also be able to send tips and virtual gifts to the content creators in real-time as the broadcast continues so as to win the attention of the content creator.

Users may even be able to participate in an on-line multiplayer game from the broadcast room website. Such games may be known as “live-stream games.” Live-stream games may have certain advantages over typical multi-player on-line games as the game itself is streamed and provided as a game-as-a-service and no separate game application need be downloaded and installed on the user's device.

While ordinary web browsers are generally used to view live-streamed broadcasts, participate in associated chatrooms, and to play live-stream games, specialized browsers for desktop computers and/or mobile devices may be used to enhance the live-stream experience.

### SUMMARY

A method for participating in a live broadcast via a viewer device includes running an application on the viewer device; using the running application to access a live broadcast that is being streamed by a streaming platform within an associated broadcast room; monitoring, by the running application, an operating instruction issued by a user of the viewer device; and controlling, by the running application, an operation of an interactive element associated with the broadcast room that is not managed by a platform of the streaming platform, based on the monitored operating instruction, the operation of the interactive element being observable only to at least one participant of the broadcast room. The at least one participant of the broadcast room includes the user, a content creator of the live broadcast, or another viewer using a device that is running the application to access the broadcast room.

A method for interactive live broadcasting via viewer device includes browsing, via a user interface of an application running on the viewer device, one or more broadcast-room pages on one or more broadcast platforms, wherein broadcast content of each of the one or more broadcast-room pages is created and streamed by at least one streamer device to a corresponding broadcast platform of the one or more broadcast platforms; receiving, by the viewer device, an interactive operation instruction directly sent from another viewer device that is browsing the at least one broadcast-room page at the same time or forwarded by the at least one streamer device from the another viewer device, wherein the interactive operation instruction is additionally generated from the application rather than an intrinsic function of the one or more broadcast-room pages, and wherein the interactive operation instruction includes at least one of a viewer accessory control instruction, voice/text/video messaging instruction, game invitation or game interaction instruction; and in response to receiving the interactive operation instruction, generating, by the application, an interactive functionality corresponding to the interactive operation instruction.

A method for interactive online entertainment via user equipment includes visiting, via a user interface of an application running on a first user equipment, one or more web-pages directed to online entertainment; monitoring, by the first user equipment, interactive operation input by a first user with respect to at least one web-page of the one or more web-pages directed to online entertainment, wherein the interactive operation acts on an interactive element that is additionally configured by the application and is not an intrinsic function of the at least one web-pages directed to online entertainment; in response to detecting the interactive operation, generating, by the application, an interactive operation instruction for interacting with the at least one web-pages directed to online entertainment; sending the interactive operation instruction to an application running on a second user equipment that is accessing the at least one web-pages directed to online entertainment and/or a viewer accessory thereof, which enables the first user to obtain feedback of the interactive operation while browsing the at least one web-page, wherein the online-entertainment of the at least one web-page is provided through a first server to the application running on the first user equipment and the application running on the second user equipment respectively; receiving, by the application running on the second user equipment, the interactive operation from the first user equipment, wherein the application running on the first user equipment communicates with the application running on the second user equipment through a second server; and in response to receiving the interactive operation instruction, generating, by the application running on the second user equipment, an interactive functionality corresponding to the interactive operation instruction.

A system for live broadcasting includes a first device generating live broadcast content and sending the generated live broadcast content to a first server maintained by a first streaming platform, the first server publishing a first live broadcast based on the generated live broadcast content; a second server publishing a second live broadcast; and a viewer device running an application for accessing the first live broadcast and the second live broadcast. The application is configured to display a representation of the first live broadcast and the second live broadcast, simultaneously, to a user of the viewer device. The application is further configured to receive a selection of the first live broadcast from the user and display the first live broadcast to the user while superimposing a control panel for controlling an operation of a streaming accessory in communication with the first device, communication between the application and the streaming accessory managed by a third server that is not associated with the first streaming platform.

A method for participating in an interactive broadcast, performed by a first viewer device. The method includes running a first application on the first viewer device, accessing, via the first application, online entertainment data associated with an online platform, and in response to trigger data received by the first application, generating a first instruction to control an operation of an interactive element based on the triggered data. The online entertainment data is accessible by at least one of a second viewer device configured not to run the first application, or a third viewer device configured to run the first application. The first application is configured to initiate the operation of the interactive element. The operation of the interactive element is observable to at least one of the first viewer device or the third viewer device, but not observable to the second viewer device.

A first viewer device includes a memory storing computer-readable instructions, and a processor coupled to the memory and configured to execute the computer-readable instructions. The computer-readable instructions, when executed by the processor, cause the processor to perform operations including: running a first application on the first viewer device, accessing, via the first application, online entertainment data associated with an online platform, and in response to trigger data received by the first application, generating a first instruction to control an operation of an interactive element based on the triggered data. The online entertainment data is accessible by at least one of a second viewer device configured not to run the first application, or a third viewer device configured to run the first application. The first application is configured to initiate the operation of the interactive element. The operation of the interactive element is observable to at least one of the first viewer device or the third viewer device and not observable to second viewer device on the online platform.

A non-transitory computer-readable medium storing instructions that, when executed by a processor of a first viewer device, cause the processor to perform operations including: executing a first application on the first viewer device, accessing, via the first application, online entertainment data associated with an online platform, and in response to trigger data received by the first application, generating a first instruction to control an operation of an interactive element based on the triggered data. The online entertainment data is accessible by at least one of a second viewer device configured not to run the first application, or a third viewer device configured to run the first application. The first application is configured to initiate the operation of the interactive element. The operation of the interactive element is observable to at least one of the first viewer device or the third viewer device, but not observable to the second viewer device.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a user interface (UI) element of the Consolidated Browser in accordance with exemplary embodiments of the present disclosure;

FIG. 2 is a schematic diagram illustrating a live-stream UI of the Consolidated Browser in accordance with exemplary embodiments of the present disclosure;

FIG. 3 is a schematic diagram illustrating a connected hardware UI of the Consolidated Browser in accordance with exemplary embodiments of the present disclosure;

FIG. 4A is a schematic diagram illustrating a system for interactive web browsing in accordance with exemplary embodiments of the present disclosure;

FIG. 4B is a schematic diagram illustrating a system for interactive broadcasting in accordance with additional exemplary embodiments of the present disclosure;

FIG. 5 is a flowchart illustrating a method for interactive web browsing in accordance with an exemplary embodiment of the present disclosure;

FIG. 6 is a signal diagram illustrating an approach for performing such an interaction;

FIG. 7 is a diagram representing the Connect APP and some of the functionality made available thereby in accordance with exemplary embodiments of the present disclosure;

FIG. 8 is a diagram representing a connected device control panel within the Consolidated Browser App in accordance with exemplary embodiments of the present disclosure;

FIG. 9 is a flowchart illustrating a method for interactive web browsing in accordance with exemplary embodiments of the present disclosure;

FIG. 10 shows an example of a computer system capable of implementing the method and apparatus according to embodiments of the present disclosure;

FIG. 11 is a diagram representing an interface of the first application in accordance with exemplary embodiments of the present disclosure;

FIG. 12 is a diagram representing an interface of the first application in accordance with exemplary embodiments of the present disclosure;

FIG. 13 is a diagram representing a portion of the interface of the first application in accordance with exemplary embodiments of the present disclosure;

FIG. 14 is a diagram representing interfaces of two applications in accordance with exemplary embodiments of the present disclosure;

FIGS. 15A-15D are diagrams representing interfaces of two applications in accordance with exemplary embodiments of the present disclosure;

FIG. 16 is a diagram representing an interface of the first application in accordance with exemplary embodiments of the present disclosure;

FIG. 17 is a diagram representing interfaces of two applications in accordance with exemplary embodiments of the present disclosure;

FIG. 18 is a diagram representing an interface of the first application in accordance with exemplary embodiments of the present disclosure;

FIG. 19 is a diagram representing an interface of the first application in accordance with exemplary embodiments of the present disclosure; and

FIGS. 20A-20C are diagrams representing an interface of the Consolidated Browser App in accordance with exemplary embodiments of the present disclosure.

### DETAILED DESCRIPTION

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present disclosure provide an approach for interactive web-browsing that utilizes a specialized browser application running on a computer or mobile device, such as a smartphone or tablet, that is able to connect to one or more live-streaming sessions, over multiple live streaming platforms, and provide a streamlined and specialized user interface therein for viewing the live-stream, participating in a chat room associated with the live-stream, playing a video game associated with the live-stream and/or remotely controlling the operation of a sex toy device in the possession of a content creator of the live-stream and/or having the operation of a sex toy device in the user's possession controlled by the content creator and/or another participant in the live-stream.

The specialized browser may either be downloaded from an application repository associated with a user's device, such as APP STORE provided by Apple Inc. or GOOGLE PLAY provided by Alphabet Inc. or may be independently downloaded and installed (e.g., sideloaded) into the user's device. The specialized browser may combine features typical of a mobile browser, such as accepting URLs and rendering webpages, but the specialized browser may add to this capability, certain specialized capabilities for managing live-streaming sessions over multiple platforms, including providing customized user interfaces and consolidated alerts, and managing interactions and control over remotely operated sex toy devices. The specialized browser may be referred to herein as the Consolidated Browser.

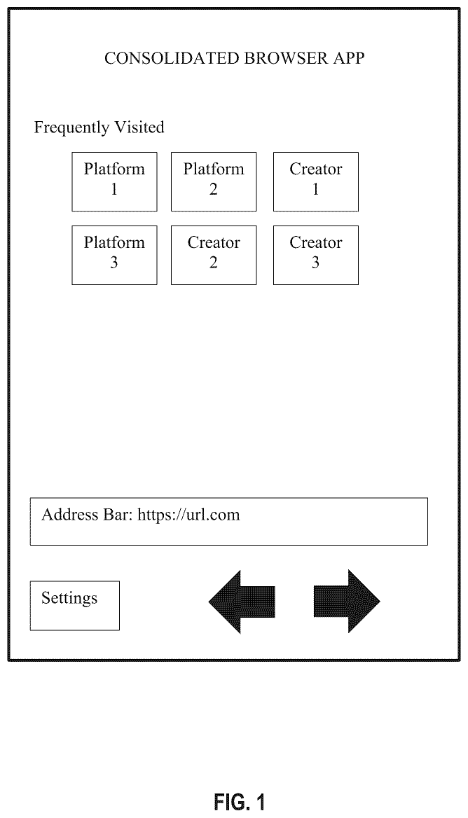

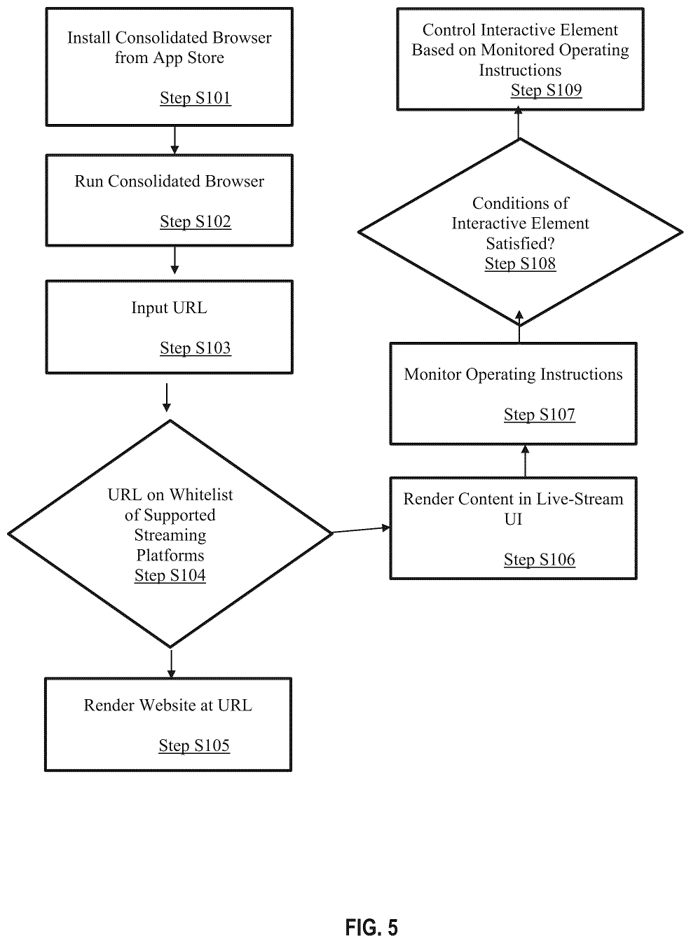

FIG. 1 is a schematic diagram illustrating a user interface (UI) element of the Consolidated Browser in accordance with exemplary embodiments of the present disclosure. FIG. 5 is a flowchart illustrating a method for interactive web browsing in accordance with an exemplary embodiment of the present disclosure, referring to FIGS. 1 and 5, using a viewer device, such as a smartphone, a user may first initiate the installation of the Consolidated Browser from an application repository (e.g., an app store) (Step S101). The user may then execute the Consolidated Browser app after it has been installed (Step S102).

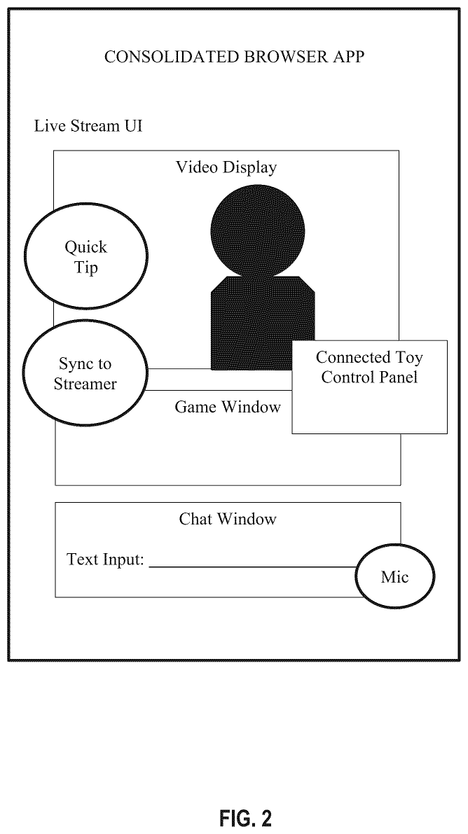

Exemplary embodiments of the present disclosure may thereby provide a user an address bar where the user can enter a URL or search criteria for searching for a particular URL. The user may input a URL within the address bar (Step S103). The Consolidated Browser may determine whether the input URL corresponds to a live-streaming platform or another form of website, for example, by consulting a whitelist of supported live-streaming platforms (Step S104). If the Consolidated Browser determines that the URL corresponds to another website, then the URL will be rendered as a website, for example, using an available rendering engine such as WEBKIT provided by Apple Inc., BLINK, provided by Alphabet Inc., GECKO provided by MOZILLA, or another suitable rendering engine (Step S105).

Where the Consolidated Browser determines that the URL corresponds to a supported live-streaming platform or another type of entertainment-enabled website for delivering content pre-registered in a specially supported website white list, rather than rendering the URL website, the Consolidated Browser will interface directly with the live-streaming platform to provide its livestreams to the Consolidated Browser's consolidated UI in which multiple live-streams across multiple different platforms may be accessed and participated in using a unified UI (Step S106) or to the Consolidated Browser's specialized UI such as a broadcast room page re-rendered like FIG. 2. Thus, exemplary embodiments of the present disclosure may determine whether an entered website URL corresponds to a specially supported website, and where it does, rather than rendering the website in a traditional manner, the website may be re-rendered in such a way as to provide enhanced interactive functionality within the Consolidated Browser app itself, such that the viewer/user can interact through a means of communication that is independent of the specially supported website and is handled directly by the Consolidated Browser and its assisting webservices to facilitate a more direct and engaging line of communication between and among viewer/users and the content provider/streamer, either by text chat, voice chat, video chat, direct control of each other's sex toys, and/or by the control of cameras or other streaming accessories corresponding to the content provider/streamer or any other device that contributes to the content creation while the viewer/user simultaneously participates in the live-stream via the associated streaming platform.

FIG. 2 is a schematic diagram illustrating a live-stream UI of the Consolidated Browser in accordance with exemplary embodiments of the present disclosure. As can be seen from this figure, the live-stream UI may display the live stream video, a chat window for participating in a chat associated with the live-stream, and various other elements which will be described in greater detail below.

As can be seen from FIG. 1, the Consolidated Browser may even maintain a list of recently/frequently visited live-streaming platforms and/or content creator subscriptions, proximate to the address bar, for example, on a same starting page as the address bar. Clicking or pressing on an icon associated with a given recently/frequently visited live-streaming platform may lead the user directly to a page showing available live streams associated with that platform. The user may then click on an available live stream to begin participation therein.

The user may also choose to subscribe/follow a particular content creator and the Consolidated Browser may send an alert to the user whenever that content creator has a livestream, regardless of the platform it is on. The Consolidated Browser may accomplish this task by interacting with a central server that checks for live streams across all supported platforms.

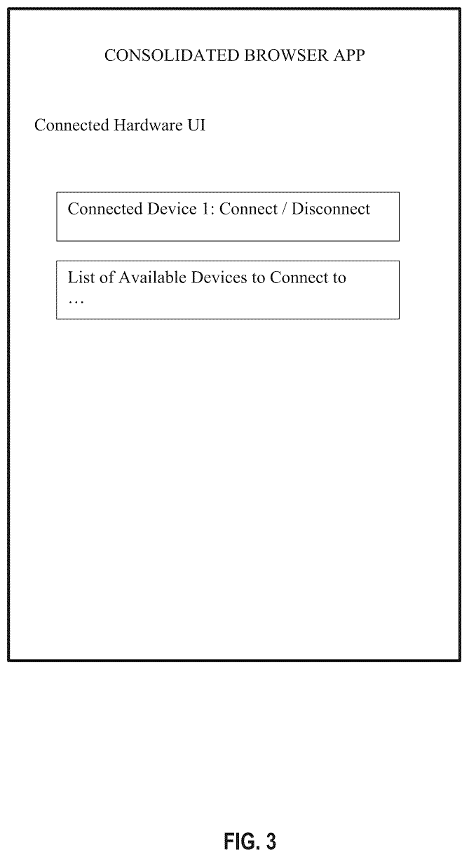

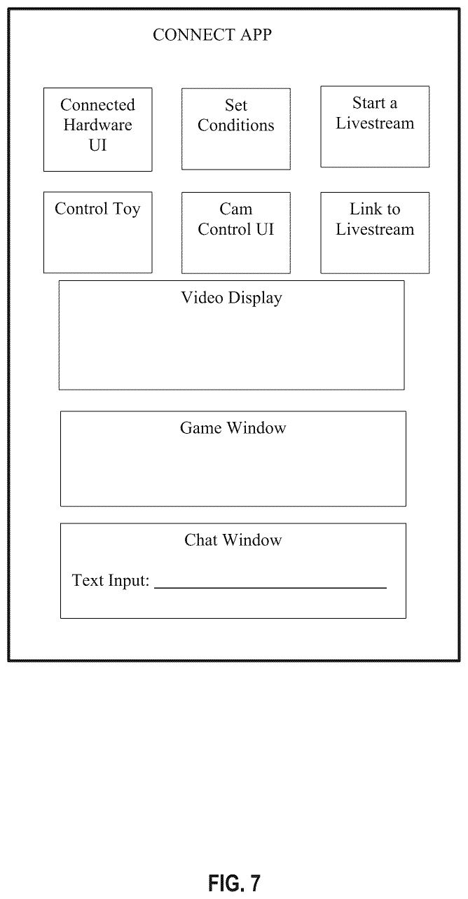

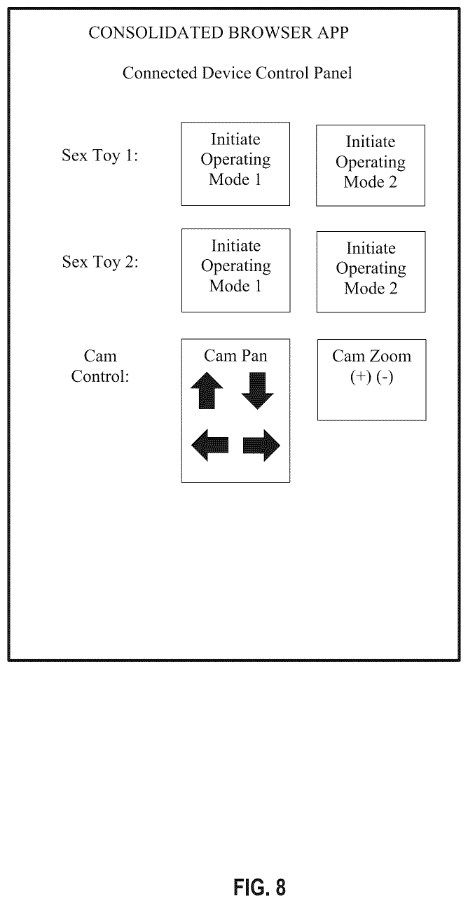

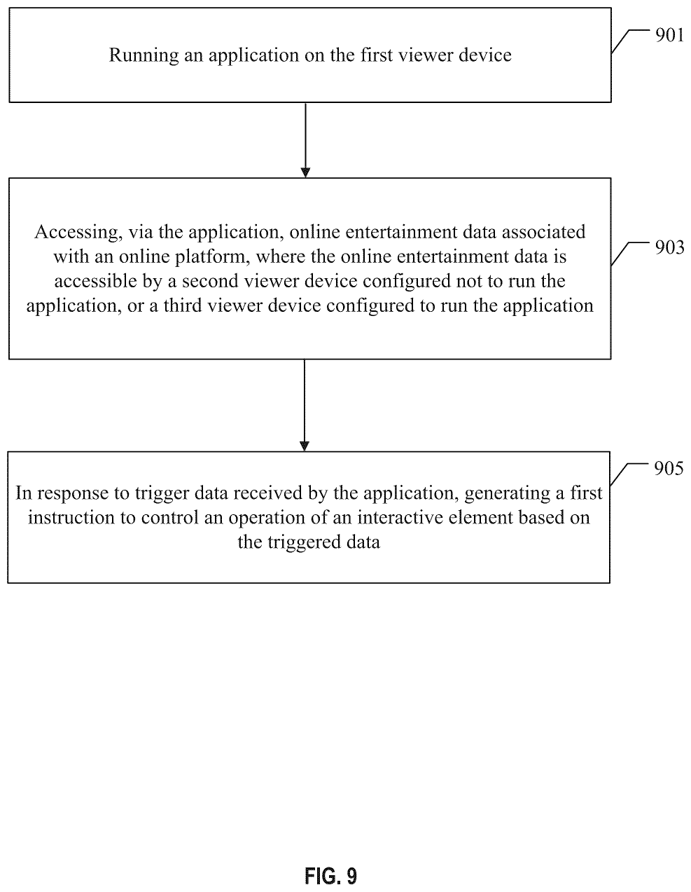

As mentioned above, the Consolidated Browser may also provide a UI for the user to connect the Consolidated Browser to a local sex toy in the possession of or in proximity to the user for the purpose of offering access/control of this local sex toy to other viewers or content creators over live-streams. FIG. 3 is a schematic diagram illustrating a connected hardware UI of the Consolidated Browser in accordance with exemplary embodiments of the present disclosure. The Consolidated Browser may provide this access/control either by interfacing with access provided by the particular live-streaming platform or by a direct connection managed by the central server that bypasses the need to go through the live-stream platform, for example, where the user is using the Consolidated Browser and the content creator is using a compatible app or service (such as the Connect APP illustrated in FIG. 7) that is similarly in communication with the central server supporting the Consolidated Browser. In this respect, the content creator may make use of the central server to register a sex toy for remote control and the user may make use of the control panel functionality, such as that illustrated in FIG. 8, provided by the same central server to establish access/control of a sex toy of a content creator who is live streaming on a live streaming platform, without the control necessary being managed by the live streaming platform.

FIG. 7 is a diagram representing the Connect APP and some of the functionality made available thereby. The Connect APP, for example, may provide the content creator with a UI for connecting hardware, a UI for controlling connected sex toys, a UI for establishing gating conditions for control of their toys and cameras, a UI for controlling their own camera, a UI for starting a livestream on a streaming platform, and a UI for linking an existing livestream to the Connect APP. Other UI elements may also be included, for example, there may be a UI element for each function of the Connect APP discussed and/or described herein.

FIG. 8 is a diagram representing a connected device control panel within the Consolidated Browser App in accordance with exemplary embodiments of the present disclosure. One or more of these functions may be gated by the satisfaction of conditions established by the content creator, as described above, and this control panel may feature control buttons for initiating operational modes of one or more sex toys associated with the content creator and/or other viewers. The illustrated controls are symbolic but there is no limit to how detailed the control of the devices may be. In addition to controlling the sex toys, this control panel, or a similar control panel, may be used to control the operation of the camera of the content creator, including, but not limited to, directional panning and/or rotation, and zooming in/out.

The Consolidated Browser may additionally offer a filtering function to the user so that a browsing page of the Consolidated Browser may list, or graphically display, multiple broadcast rooms across different broadcast platforms. The respective content creators/models for these displayed broadcast rooms may use their devices to run software (locally or over one or more web services) to interface with the central server and locally connect their sex toys thereto so as to stream their content via different broadcast servers that correspond to broadcast platforms.

As discussed above, the Consolidated Browser may provide a similar UI for each live stream regardless of which platform that live stream is hosted on. Referring back to FIG. 2, this live stream UI may provide a window for playing the live-stream video, a window for showing chats, and a window for entering text to send to the chat. The live stream UI may also prominently show a quick tip icon that may float over the video window (although it may be moved) and may permit the user a quick way to send a monetary tip or some other transfer of points to the content creator, with the particulars of the transaction being managed by the Consolidated Browser app or its central server. Thus, the Consolidated Browser may be pre-programed with information on how to consummate a tip transaction for each of the supported platforms so as to handle tipping seamlessly to the user. In another embodiment, the quick tip icon may be used to autopilot an original html element (e.g., a tip sending button native to the live-stream platform) of the website.

Another quick icon may be similarly displayed along with the quick tip icon. This icon may be a “sync to streamer” icon that allows for the operation of a user's sex toy to be synchronized to the operation of the content creator's sex toy. When activated, the Consolidated Browser may monitor sex toy activity of the content creator and then replicate this activity to the user's sex toy that is linked to the device that the Consolidated Browser is running on, for example, via Bluetooth.

The live stream UI may also provide UI elements for performing all functions that are performable by directly connecting to the live stream platforms, for example, by accessing using a conventional web browser, however, each of these functionalities may be represented in a unified way so as to provide the user with a seamless experience that is consistent across diverse platforms.

For example, microphone functionality (“Mic”) may be provided to allow the user to activate the microphone of the user's device so as to contribute audio to the live-stream or directly to the content creator. The microphone functionality may be used either to send a recorded message that the content creator can listen to when ready, or to send audio in real-time to be heard by the content creator and/or other viewer participants.

When the Consolidated Browser is rendering a live-stream from information derived from a live stream platform, the Consolidated Browser may continue to monitor for special operating instructions of the viewer (Step S107) that may be used to perform operations specific to the Consolidated Browser, as opposed to engaging with features of the live-stream platform. These operating instructions may relate to, for example, the games played within the live stream chat room or the control of connected devices such as cameras and sex toys.

The microphone feature, as well as other features described herein, may be restricted from use until a tip of a predetermined value is transferred to the content creator, or by other conditions set by the content creator. In this way, the special functionality of the Consolidated Browser may be gated by various conditions, such as a tipping condition. For example, the icons representing these features may be hidden or deactivated (e.g., grayed out) prior to the predetermined conditions being met. The predetermined conditions are not necessarily limited to tipping conditions as predetermined conditions may include, for example, earning a VIP designation within the Consolidated Browser app, purchasing an NFT privilege, connecting to a specific toy via the Consolidated Browser, etc. The Consolidated Browser may therefore check for the satisfaction of conditions when an instruction has been detected (Step S108). The Consolidated Browser may receive these tip conditions from the content creator and then gate access to these features in a manner consistent with the requests of the content creator submitted either through the Consolidated Browser or through a control panel accessible by a conventional browser, for example, the control panel being maintained by the central server, or though functionality of the individual platforms. Thus, when instructions have been detected (in Step S107) and it is determined that the necessary conditions have been satisfied (in Step 108) then the Consolidated Browser may extend control of the interactive element to the viewer (Step S109), for example, to play a game, control a sex toy of the content creator, and/or control a camera of the content creator.

The Consolidated Browser, for example through its associated central server, can directly handle text chats, interactive video games, and the sending of multimedia, among the user, the content creator, and other users accessing a same livestream using the Consolidated Browser, without going through the platform. In this way, communications associated with a live stream may circumvent the live stream platform to provide a greater level of engagement that is available only to users of the Consolidated Browser and not to other users that may be directly accessing the live stream through the platform's own web portal.

The Consolidated Browser may also provide to the user a control panel to control a mode of operation of a content creator's connected sex toy. This feature may also be gated by the satisfaction of a predetermined tip. The control panel, by having both the user and the content creator utilize the Consolidated Browser, may provide a very high level of control over the sex toy that might not otherwise be possible when having to go through the live streaming platform alone, and as discussed above, this control may be managed by the central server rather than the live streaming platform. Moreover, neither the user nor the content creator need make use of browser plugins and the like. However, where the content creator is not utilizing the Consolidated Browser, the Consolidated Browser may still manage a connection between the user's control panel and a browser plugin of the content creator designed for providing remote control of the content creator's sex toy.

The user may jump back and forth between the control panel and the live stream UI, for example, by the use of a fast switch icon displayed on each UI or the control panel may be implemented as a floating element on top of the live stream UI. The Consolidated Browser may also grant the content creator access to the connected sex toys of the user in a similar manner and the user can select among his registered connected sex toys to grant remote access to.

According to some exemplary embodiments of the present disclosure, and as mentioned above, the Consolidated Browser may provide to the user, for example, upon the satisfaction of a predetermined tip, control over the content creator's camera. For example, pan, tilt, zoom, and camera switch functionality may be transferred to the user. This may be implemented by the content creator registering one or more cameras with the Consolidated Browser and then control over these cameras may be placed under the direction of the user within a control panel, in a manner similar to how the user may gain control to a sex toy of the content creator. The central server of the Consolidated Browser may be used to negotiate camera/sex toy control in a secure environment without having to open control over a website such as the web portal of the live stream platform.

As discussed above, the Consolidated Browser may manage the play of interactive games between one or more users and the content creator. The Consolidated Browser may be used to render advanced graphics and/or sound associated with an interactive game occurring on the live stream platform, or the Consolidated Browser may host its own games that are played among live stream participants (e.g., the user, other viewers, and the content creator) while circumventing interaction with the platform.

The user may select a game play icon from the live stream UI and may bring up a game play UI where the user can create a new game or participate in a game being played. The game may be participated in by all live stream participants utilizing the Consolidated Browser and the Consolidated Browser may also provide a rendering for other games hosted on the platform. In this way, each participant may see and interact with the game being played. Rewards for winning games may similarly be used to grant access to the sort of controls discussed above that are gated.

The central server may monitor live streams, even when the user is not, so that the Consolidated Browser may be able to present to the user playbacks of prior live streams that were missed, or provide instant-replay type functionality where the user is participating in a live stream. The Consolidated Browser may even be able to provide playback of synchronized sex toy control, in addition to playback of live stream audio/video by recording toy control commands embedded within the recording of the live stream. Recordings may be maintained on the central server for a time, in a manner consistent with the requirements of the platform and content creator, and once again, this functionality may be gated by a tipping requirement.

The Consolidated Browser may provide other features such as matching sex toy control to website content accessed by the Consolidated Browser as a standard website, for example, by matching sex toy control to music, movies, audiobooks, etc. The user may be able to initiate, end, and adjust this sex toy control rendering by accessing a browsing control panel.

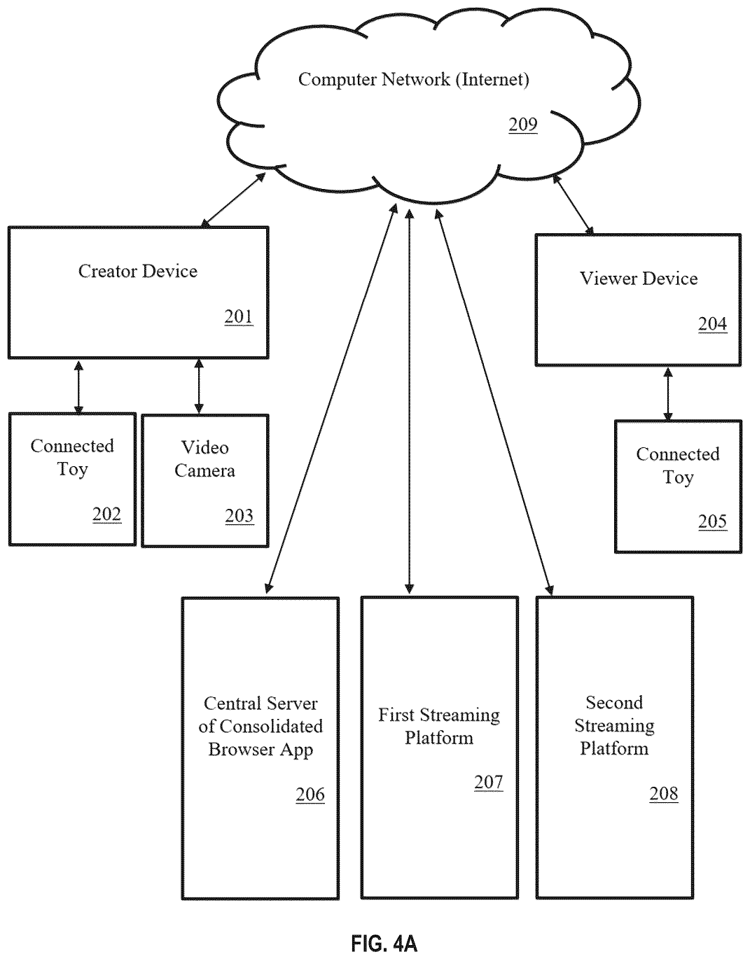

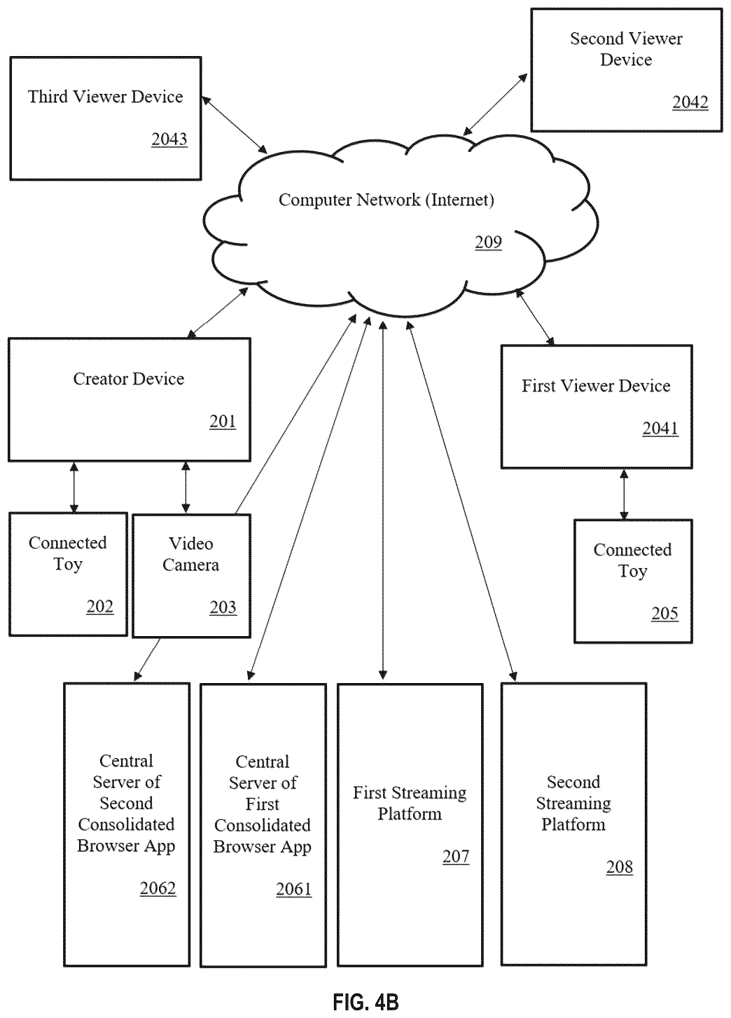

FIG. 4A is a schematic diagram illustrating a system for interactive web browsing in accordance with exemplary embodiments of the present disclosure. As can be seen from this figure, a creator device 201 may run an application or web service for connecting to a central server 206 of the consolidated browser. This application or web service may be, for example, a version of the Consolidated Browser, but may alternatively be a custom application developed for granting content creators direct access to the functionality of the Central Server 206. The creator device 201 may be connected to a sex toy 202 via a local connection such as Bluetooth or wired USB. This connection may be managed by the application or web service discussed above. A video camera 203 may also be connected to the creator device 201 via a wired and/or wireless connection, or the video camera 203 may be part of the creator device 201. Control of the sex toy 202 and/or the camera 203 may be managed by the creator device 201 and this control may be granted remotely in accordance with the Consolidated Browser. The creator device 201 may be connected to a wide area computer network 209, such as the Internet.

The central server associated with the Consolidated Browser app 206 may also be connected to the computer network 209 so that the content creator app/web service (referred to herein as the “Connect APP”) may contact the central server 206 over the computer network 209 so that the central server 206 may negotiate functionality of the Consolidated Browser, given to the viewers using the Consolidated Browser, that is not handled by the streaming platforms.

While there may be any number of streaming platforms whitelisted within the Consolidated Browser, each streaming platform may operate its own server(s) for hosting the live streams on its platform. A first streaming platform server 207 and a second streaming platform server 208 are shown for simplicity and each of these servers connects to the computer network 209 and in that way, the central server of the consolidated browser app 206 is able to observe data from the various streaming platforms.

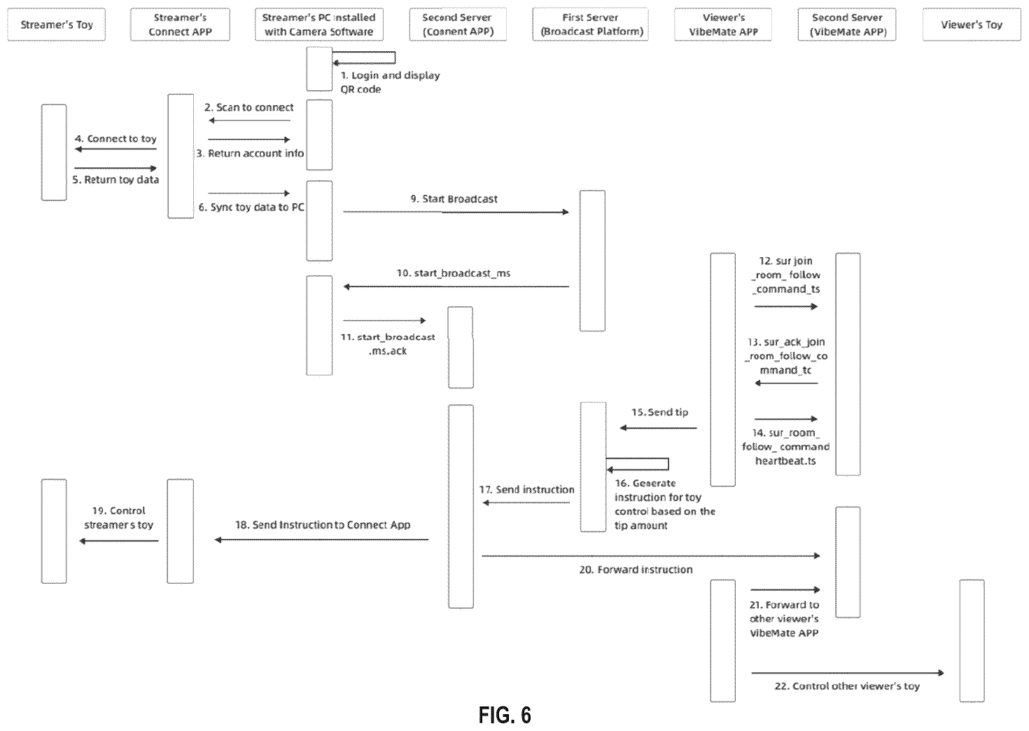

There may be any number of viewers running the Consolidated Browser and each may have a viewer device 204, which may also be a smartphone, etc. The viewer device 204 may also have a sex toy 205 connected thereto, for example, for performing the synchronization discussed above. As discussed above, exemplary embodiments of the present disclosure may utilize the Consolidated Browser to manage various interactions between the viewer and the content creator (“streamer”) outside of the integration of the streaming platform. An example of one such interaction is the “sync with streamer” functionality discussed above in which the Connect APP manages the synchronization of operation of a sex toy of the content creator and a sex toy of the viewer. FIG. 6 is a signal diagram illustrating an approach for performing such an interaction. This discussion is provided as an example of how the Consolidated Browser and related elements may perform many such interactions.

First, the streamer may log in to the streaming platform using a computer and display a QR code for the purpose of allowing the streamer's smartphone running the Connect APP to engage with the streaming session (1). Next, the streamer's smartphone running the Connect APP may scan the displayed QR code to engage (2). Account information may then be sent from the streamer's PC to the Connect APP running on the smartphone (3). The streamer's PC to the Connect APP running on the smartphone may then connect to the streamer's sex toy (4) and the streamer's sex toy may return toy data pertaining to the operation thereof (5). The Connect APP running on the smartphone may then send the toy data to the streamer's PC (6).

The streamer may then begin the live-streaming session with the server of the streaming (“broadcast”) platform (9) (“the first server”). The first server may interact with the streamer's PC to manage native interactions of the broadcast platform (10). Native interactions may include those interactions that the broadcast platform is known to manage, such as receiving streaming signals and relaying those signals to the viewers of the live-stream and managing basic chat room functionality such as sending and broadcasting text messages amongst the viewers and streamer and facilitating the transaction of tipping, which is the sending of points, tokens, and other representations of monetary value from the viewers to the broadcaster. The streamer's PC may then interact with a server of the Consolidated Browser (“second server”), via the Connect APP, to engage the second server to handle various interactions associated with the live stream that are not managed by the broadcast platform (i.e., to manage interactions that are not native to the broadcast platform) (11).

The viewer, running the Consolidated Browser, may then engage with the second server to join the live stream (12). The second server may interact with the viewer's smart phone running the Consolidated Browser to negotiate interactions and to participate in those functions provided by the Consolidated Browser that are not native to the streaming platform (13 & 14). The Consolidated Browser may also intermediate the interaction of the viewer with the native functionality of the live stream so as to provide the unified user experience discussed above. This may include the rendering of the live stream within the Consolidated Browser and the sending of a tip from the viewer to the streamer, which may be performed though the first server managed by the broadcast platform (15). The broadcast platform may thereafter generate and/or pass instructions for sex toy control to the second server (17) whose responsibility is to implement toy control commands. The second server may send the toy control commands to the streamer's smartphone running the Consolidated Browser (18) where the commands may then be passed back to the streamer's sex toy (19) thereby allowing the viewer to control the operation of the streamer's sex toy.

The second server, associated with the Consolidated Browser, may then forward sex toy instructions that are based on the instructions being implemented by the streamer's sex toy, back to the viewer's smart phone running the Consolidated Browser. These instructions may be referred to herein as “feedback” as they are instructions for the viewer's sex toy based on the operation of the streamer's sex toy. Here, this interaction is illustrated as including passing instructions between two implementations of the second server (20) and then forwarding instructions from the second implementation of the second server to the viewer's device (21). However, it is to be understood that the second server may be embodied as a distributed server having any number of actual server computers, as is also the case for the first server associated with the broadcast platform. For example, here, the first implantation of the second server may be associated with the Connect App of the streamer's PC while the second implementation of the second server may be associated with the Consolidated Browser (shown in this figure as the “VibeMate APP”). Alternatively, a single server may be relied upon to handle all functionality of the second server. Ultimately, however, the operation of the viewer's sex toy may be controlled according to the commands sent by the viewer's device. As the commands to control the viewer's sex toy are substantially synchronized with those of the streamer's sex toy, the “sync with streamer” functionality has been performed.

There may be additional viewers running the Consolidated Browser and viewing the same streaming content. For these additional viewers, instructions and communications from the second server associated with the Connect App may also be passed to a second server associated with their implementation of the Consolidated Browser (20) and these instructions and communications may then be passed on from the second server associated with their implementation of the Consolidated Browser to their implementation of the Consolidated browser (21) and in response, a sex toy of that viewer may be controlled (22) according to the passed instructions, for example, to implement the feedback discussed above.

FIG. 4B is a schematic diagram illustrating a system for interactive broadcasting in accordance with additional exemplary embodiments of the present disclosure. In some implementations, there are multiple viewers running an application on their respective viewer devices. The application allows the viewer to access online entertainment data associated with an online platform, such as a live-streaming platform, an entertainment-enabled website, or other similar platforms as disclosed herein. Examples of the application include a web browser application (e.g., the Consolidated Browser App discussed above), an input method application, a browser plugin, an Application Programming Interface (API), etc. As shown in FIG. 4B, two web browser applications (namely, a first consolidated browser app 2061 and a second consolidated browser app 2062), and three viewer devices (namely, a first viewer device 2041, a second viewer device 2042, and a third viewer device 2043) are provided in the system. Each of the web browser applications may be the Consolidated Browser App. Each of the viewer devices may be a smartphone, a tablet, a personal computer, etc. In some implementations, a viewer accessory may also be coupled to one or more viewer devices, respectively. Examples of the viewer accessory includes a camera, a sex toy, a microphone, etc. As shown in FIG. 4B, first viewer device 2041 may be coupled to a sex toy 205 for performing the synchronization, which is discussed above in detail and will not be repeated here.

Each of these viewer devices may have different access permissions to access all or only a portion of the online entertainment data displayed on the streaming platform (e.g., a first streaming platform 207 or a second streaming platform 208). In some implementations, first viewer device 2041 and third viewer device 2043 may execute the Consolidated Browser App while second viewer device 2042 may not execute the Consolidated Browser App. Such differentiation in the access permission may be determined by the level of membership that the viewer device is entitled to. For example, premium members may have full access to all of the online entertainment data, full authority to observe the operations of all interactive elements, or both, while regular members may enjoy only a portion or even none of the access or the authority. In the current embodiments, the online entertainment data is accessible by first viewer device 2041, second viewer device 2042, and third viewer device 2043. In some implementations, operations of the interactive elements may be observable to devices configured to execute the Consolidated Browser App, such as first viewer device 2041 or third viewer device 2043. However, some or all operations of the interactive elements may not be observable to second viewer device 2042 because second viewer device 2042 does not execute the Consolidated Browser App to control the operations of the interactive elements.

In some implementations, the access permission of the viewer device may be received and processed by the application as trigger data. The access permission of first viewer device 2041 may include one or more permissions granted, by the online platform or the application, to a logged-in user or a premium member of the online platform or the application. That is, different levels of member permissions are available, depending on the user's subscription plan or tipping amount to the content creators. Upon receiving the trigger data by the application, first viewer device 2041 may generate a first instruction to control the operation of an interactive element based on the triggered data. In some implementations, the trigger data may include an operation instruction initiated by first viewer device 2041 or a viewer accessory (e.g., connected toy 205) coupled to first viewer device 2041. The initiation may be carried out by a viewer using first viewer device 2041, such as touching a virtual button on a control panel displayed on first viewer device 2041, or pressing a physical button on the housing of first viewer device 2041.

In some implementations, the online entertainment data is hosted by a server associated with the online platform (hereinafter “platform server”). An example of the platform server is the “first sever” discussed above. In other implementations, at least a portion of the online entertainment data is hosted by a server associated with the provider of the first application (e.g., the Consolidated Browser App) (hereinafter “provider server”). An example of the provider server is the “second server” discussed above. The online entertainment data may include live stream data, streamer information (e.g., name, profile picture, social media accounts, etc.), tipping data, user data, game character data, etc. In some implementations, the online platform may manage live stream data and streamer information, while the tipping data may be managed either by the online platform (e.g., hardcoded rules) or by a hosted server (e.g., configured through the model-side settings on the hosted server, with the online platform serving to display such information). The current disclosure does not require the streamer or model to use the first application for setting the rules. As long as the underlying online entertainment data is obtained and readable by the viewer device, the streamer or model can use compatible applications or devices to set the rules.

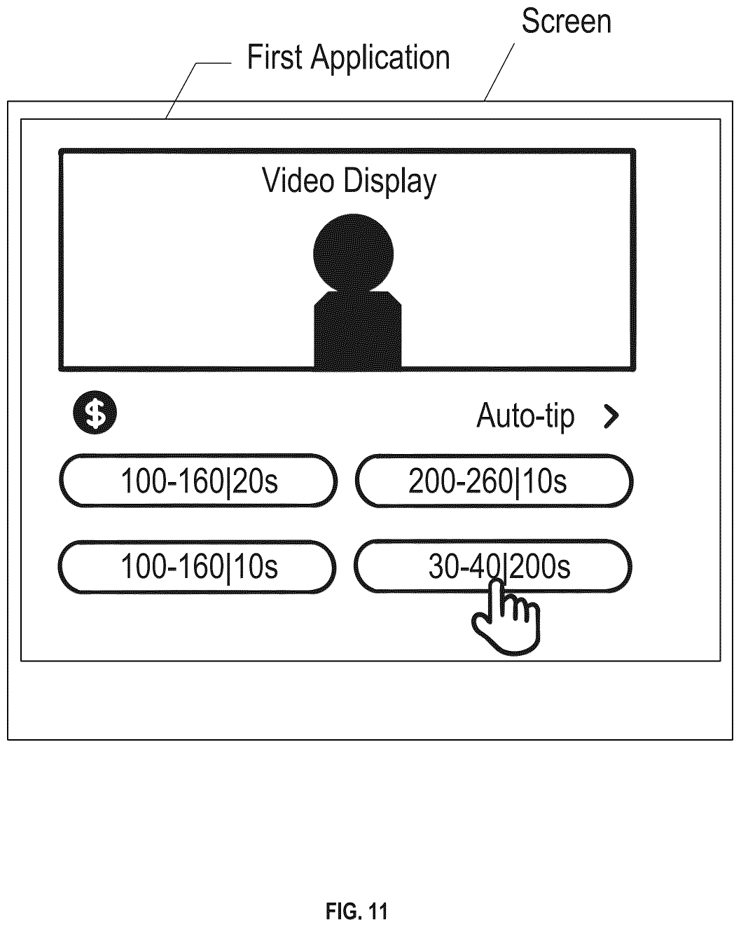

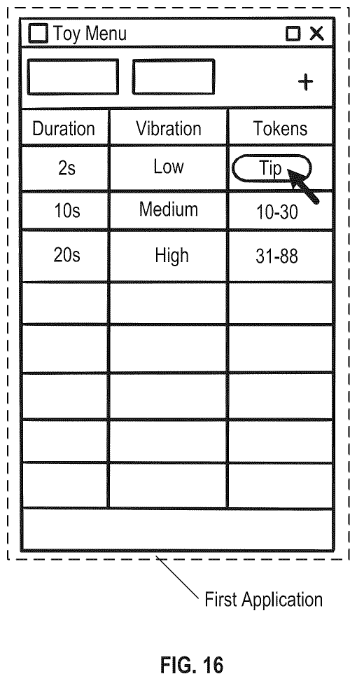

In some implementations, the application is configured to call or invoke the operation of the interactive element. For example, as shown in FIG. 11, the first application (e.g., the Consolidated Browser App) may include an interactive element on its user interface, such as a button labeled “donate,” “tip,” “subscribe,” or with a specified number of tips, which triggers a series of actions when pressed (e.g., vibration with a specified duration, type, or intensity). The Consolidated Browser App then calls a specific function or method associated with the button. For example, after touching the button to tip or subscribe for a specified duration, type, or intensity of a vibration, stimulation of a sex toy coupled to a streamer device is initiated as a result thereof. In another example, as shown in FIG. 16, the first application may include a tipping condition for the broadcast room in the form of a selection menu. The user may click on the button labeled “tip” to trigger the donation of a specified amount of tip and the performance of a specified intensity of stimulation with respect to a sex toy coupled to a streamer device.

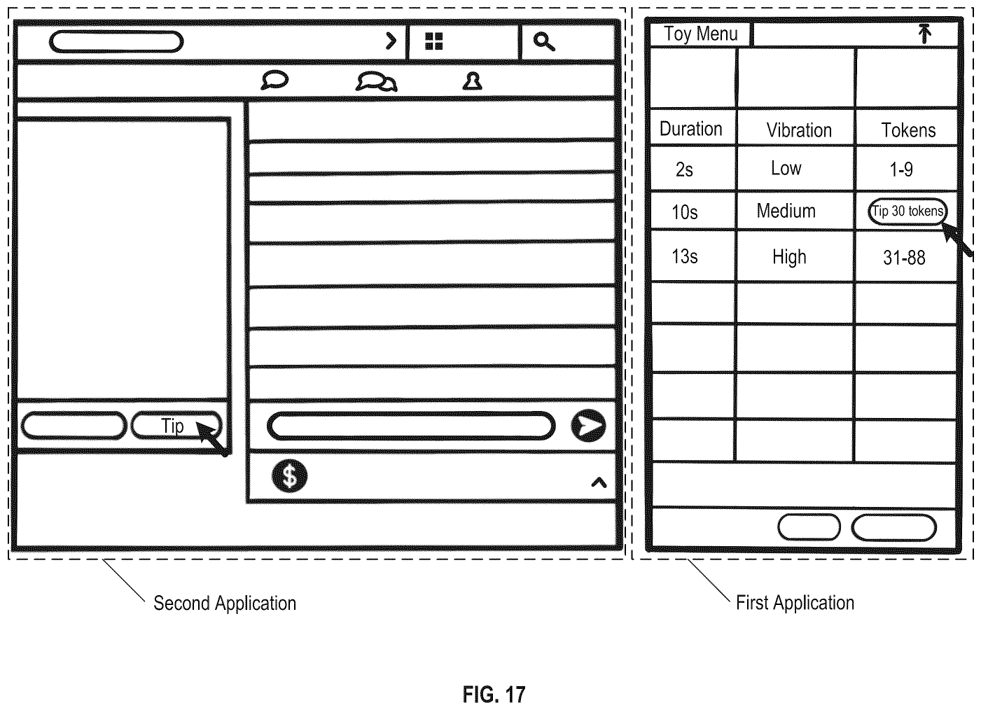

In some implementations, these interactive elements (e.g., the tipping buttons) are managed or controlled by the first application. That is, as shown in FIG. 17, these interactive elements displayed on the first application are not streamed from the online platform, as the contents from the online platform are separately displayed in the interface area of the second application. According to the present disclosure, these interactive elements of the first application can be associated with the second application. For example, the second application displays online entertainment data streamed from the platform server within the boundary of its application interface on the viewer device, which includes live stream data, streamer information, tipping data, user data, etc. Thus, the tipping function, one of the interactive elements managed or controlled by the first application, may be associated with the second application by being used to adjust the tipping data on the second application. In some implementations, the association may be performed by hardware and/or software components of the viewer device. This helps both the streamer and the viewer to keep themselves up-to-date regarding the tipping information.

In some implementations, the accessing, via the first application, the online entertainment data can be done by retrieving, via the first application and through a first preset path, the online entertainment data from the platform server. For example, the first application may directly retrieve the online entertainment data from the platform server without the need to pass by other servers. This saves storage space of other servers and thus reduces costs to some extent. In some implementations, it can be done by retrieving, via the first application and through a second preset path, the online entertainment data from the provider server. For example, the first application may first retrieve the online entertainment data from the platform server and save it to the provider server, after which the user can access the data through the first application hosted on the provider server. This allows for faster processing of the online entertainment data in subsequent broadcasting, because some of the data (e.g., tipping conditions, model identities and interests, etc.) can be directly retrieved from the provider server and displayed on the viewer device without going through the platform server.

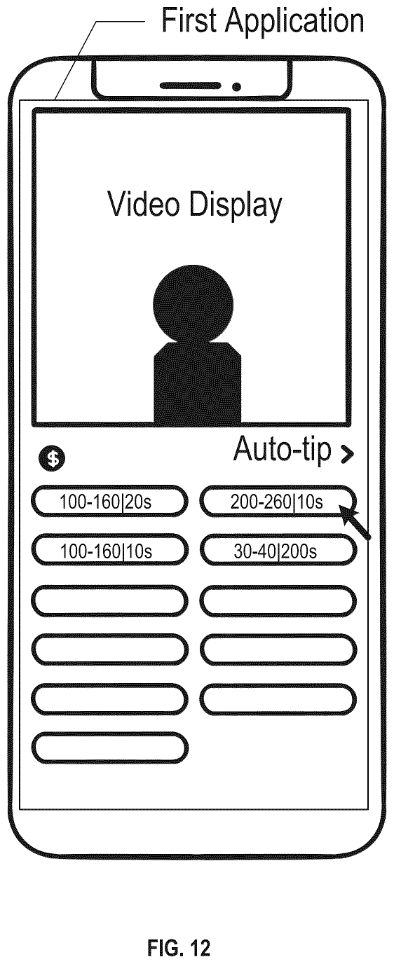

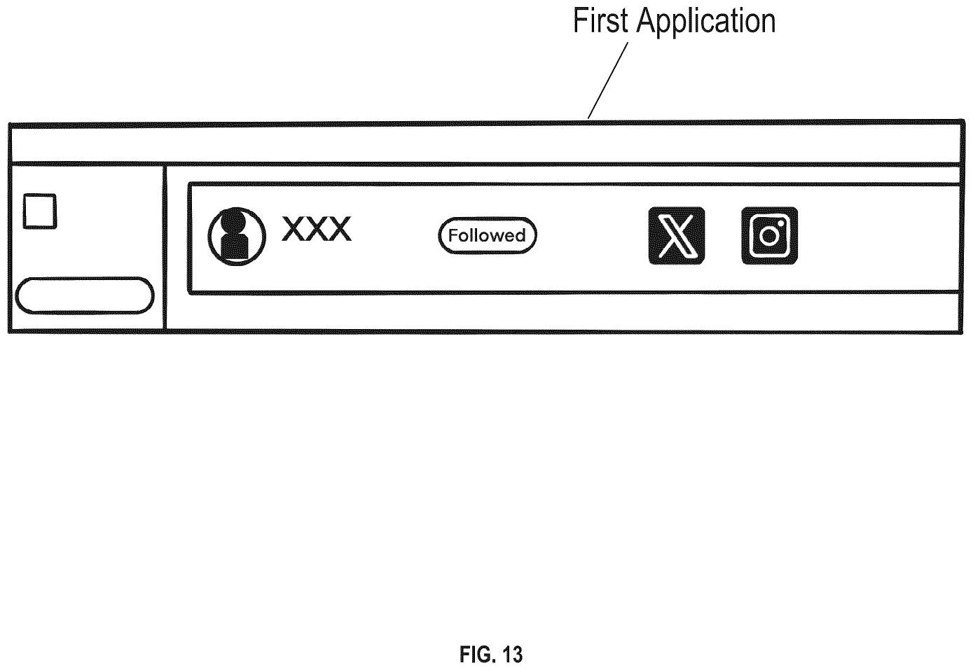

In some implementations, the provider server is configured to store information of a broadcast room from the online platform, and the first application is configured to retrieve the online entertainment data by accessing the stored information of the broadcast room. As shown in FIG. 12, the first application may retrieve the information of a broadcast room from the online platform and display the information (e.g., a video stream of a streamer in the broadcast room) on the interface of the first application. The first application may further include the interactive elements (e.g., the tipping buttons) below the video display for a viewer to tip and thus trigger the operation of a streamer accessory (e.g., sex toy) controlled by the streamer and/or other participants (e.g., viewers) in the broadcast room. In some implementations, as shown in FIG. 13, the first application may retrieve, for example, the live stream data (e.g., the duration of the live stream, the number of the viewers, etc.), streamer information (e.g., profile picture, name, social media accounts, etc.), tipping data (e.g., tipping condition, tipping statistics, etc.), and so on.

In some implementations, the accessing, via the first application, the online entertainment data associated with the online platform may include accessing page information of a broadcast room from the online platform via the first application, and retrieving corresponding online entertainment data of the broadcast room via the page information. It may further include retrieving the online entertainment data of the broadcast room from the online platform via the first application through a preset interface of the online platform. Furthermore, it may include performing image recognition on the broadcast room on the online platform via the first application, and retrieving the corresponding online entertainment data of the broadcast room.

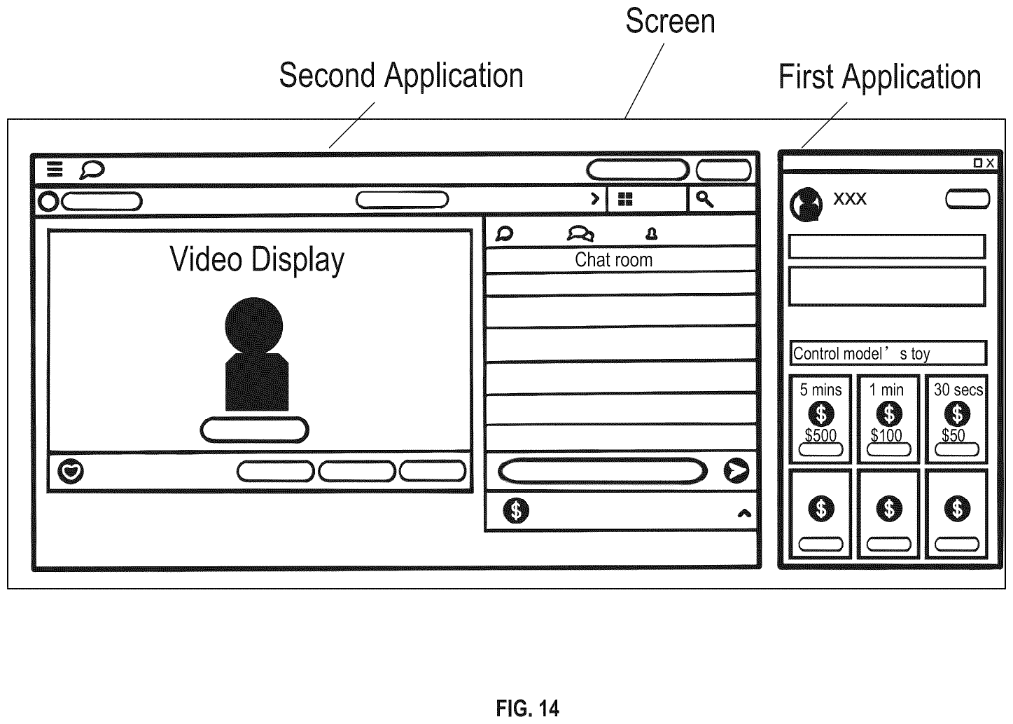

In some implementations, as shown in FIG. 14, the first application may be a browser extension, which is built using web technologies like HTML, CSS, and JavaScript and may interact with the browser's APIs to access and modify web pages, manage user data, or communicate with external servers. For example, it may access, manage, or communicate with the online platform and/or the second application disclosed herein, thereby also assisting association of interactive elements with the second application

As shown in FIG. 14, the online platform can be displayed on another application (e.g., a second consolidated browser app 2062), and the contents of the first application (e.g., first consolidated browser app 2061) and the contents of the second application (e.g., second consolidated browser app 2062) may be displayed simultaneously on a screen of first viewer device 2041. In some implementations, the contents of one of the first application and the second application are displayed on a dynamic island region, so that the view of the contents of the other application will not be substantially obstructed from being seen on the screen. The dynamic island herein refers to a dynamic, interactive area on the screen or display (e.g., a pill-shaped or circular region) of the viewer device that can display live activities or notifications from multiple applications. The user of the dynamic island can interact with both applications simultaneously without switching screens.

In some implementations, the contents of both applications can be displayed on the same screen with a transparency configuration or a split-screen configuration or on different screens of first viewer device 2041, so that the contents of one application will not be substantially obstructed by the display of contents of the other application. For example, the display area of the first application on the screen may overlap with that of the second application, but can be made partially transparent or translucent so that the contents of both applications are readable by the viewer. In some implementations, first viewer device 2041 (e.g., a smartphone or tablet) are capable of supporting multitasking and advanced display features in order to run two applications simultaneously.

As discussed above, the interactive element may include a first element associated with the second application. Upon receiving the trigger data, first viewer device 2041 may generate a second instruction to control an operation of the first element on the second application. For example, the second application may display a broadcast room with a tipping button (i.e., the first element), the user of first viewer device 2041 may click the tipping button displayed on the first application to generate an instruction, via the first application to the second application, to tip a specific amount to the creator of the broadcast room displayed on the second application, and/or to start the operation of the creator's sex toy in response to the tipping.

In some implementations, the first application (e.g., first consolidated browser app 2061) is configured to perform cross-system or cross-application operation with respect to at least one of the second application or the online platform. That is, the first application is operable to interact with or control functionalities of other applications or system components so that the first application can be used to interact with or control another application or platform.

In some implementations, the first application is a software component integrated into the second application. The software component includes a plugin, a Software Development Kit (SDK), or an Application Programming Interface (API). In some other implementations, the first application is a web browser application or an input method application, which is independent from the second application.

In addition, controlling the operation of the interactive element based on the triggered data may further include displaying a tipping condition for a broadcast room of the online platform, which is shown on the first application or the second application. For example, the tipping conditions include granting different levels of control (e.g., duration, intensity, pattern, etc.) over at least one of a streamer accessory coupled to the streamer device or a viewer accessory coupled to the first viewer device, granting different tiers of permission to access (e.g., full access, limited access, no access, etc.) various contents displayed by the streamer or the viewer in the broadcast room, and/or providing different levels of engagement with the broadcast room (e.g., message only, message with short video, etc.). Such actions may be displayed along with the broadcast room.

In some implementations, the instruction may be used to trigger a tipping action for the broadcast room of the online platform. For example, a viewer may click on one of the tipping buttons with a specific tipping amount on the first application to trigger a tipping action for a streamer on the broadcast room of the online platform.

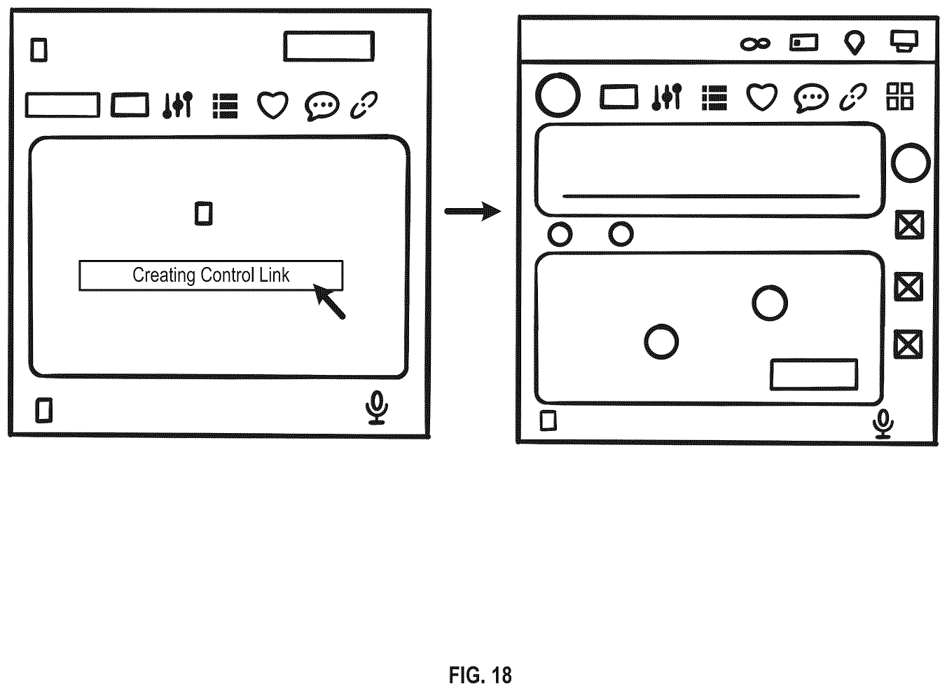

In some implementations, the instruction may be used to access a Uniform Resource Locator (URL) and display a page corresponding to the URL on the first application. For example, as shown in FIG. 18, a viewer may click a tipping button with a specified tipping amount in the first application, which triggers a URL providing a control link for controlling the streamer accessory or redirecting to the streamer's private broadcast room of the online platform, granting the viewer access to the private broadcast room after the tipping is made. It is noted that the tipping button herein is only one of the examples. It can also be a subscription button to a streamer, a like button or thumbs-up button to a content creator, etc.

In some implementations, the streamer may receive and the viewer may transmit, via the first application, the control link request from a viewer to control the stream accessory and for approval by the streamer. Upon acceptance of the control link request by the streamer, the first application may automatically trigger a tipping operation through the first application to execute a payment to the streamer. This enables the viewer to control the streamer accessory without advance payment or additional user-initiated payment actions, thereby streamlining the interaction between the streamer and the viewer. In some implementations, the first application is integrated with a keyboard input method or a broadcast room displayed on the online platform. In some implementations, the tipping operation is executed using a pre-configured payment method associated with the viewer's account. In some implementations, a notification may be provided to the user upon acceptance of the control link request and before triggering the tipping operation.

In some implementations, the first application may have access to a camera of the streamer or the viewer to capture real-time video of their respective activities. As such, the streamer or the viewer may control at least one of the streamer accessory or the viewer accessory based on the detected/captured real-time video, thereby enabling hands-free control of the accessory based on the viewer or streamer's activity. For example, the first application may access a camera of the viewer and capture real-time video of the viewer's activity (e.g., using the viewer accessory), and automatically control the streamer accessory to provide corresponding stimulation or vibration according to the captured real-time video of the viewer's activity. The stimulation or vibration of the streamer accessory may be related to (e.g. proportional to) that of the viewer accessory.

In some implementations, the instruction may be used to modify contents displayed on an interactive interface of the second application. For example, a viewer may click the tipping button with a specified amount in the first application, which triggers removal of pixelation or blurring from the contents in the streamer's broadcast room on the online platform, thereby granting the viewer access to the uncensored video stream after the tipping is made.

In some implementations, the instruction may be used to display push information for notifications, ads, or recommendations (e.g., other broadcast rooms) to enhance viewer engagement and provide additional value for the viewer. For example, a viewer may click the like button, and the first application or the online platform may push notifications that direct the viewer to ads or external websites for additional information or services. The notification may appear as a banner at the top of the screen or as a pop-up window. In another example, the first application or the platform may recommend other broadcast rooms to viewers based on their interests or viewing history.

In some implementations, as illustrated in embodiments of FIG. 14, the first application and the second application are operated and displayed side-by-side on the first viewer device. The contents of the first application are displayed independently from an interactive interface displaying the streamed contents of the second application. The streamed contents may include audio, video, data, or any combination of the above. The streamed contents may be live, deferred live, pre-recorded, or any combination of the above. The live-streaming aspect of the streamed contents has been extensively described above and thus will not be repeated herein. In some implementations not shown herein, the contents of the first application are displayed as an embedded control panel within the interactive interface of the second application. In both the above implementations, the contents of the first application are displayed without obstructing the contents displayed on the interactive interface of the second application. Therefore, user experience is improved over the existing technology.

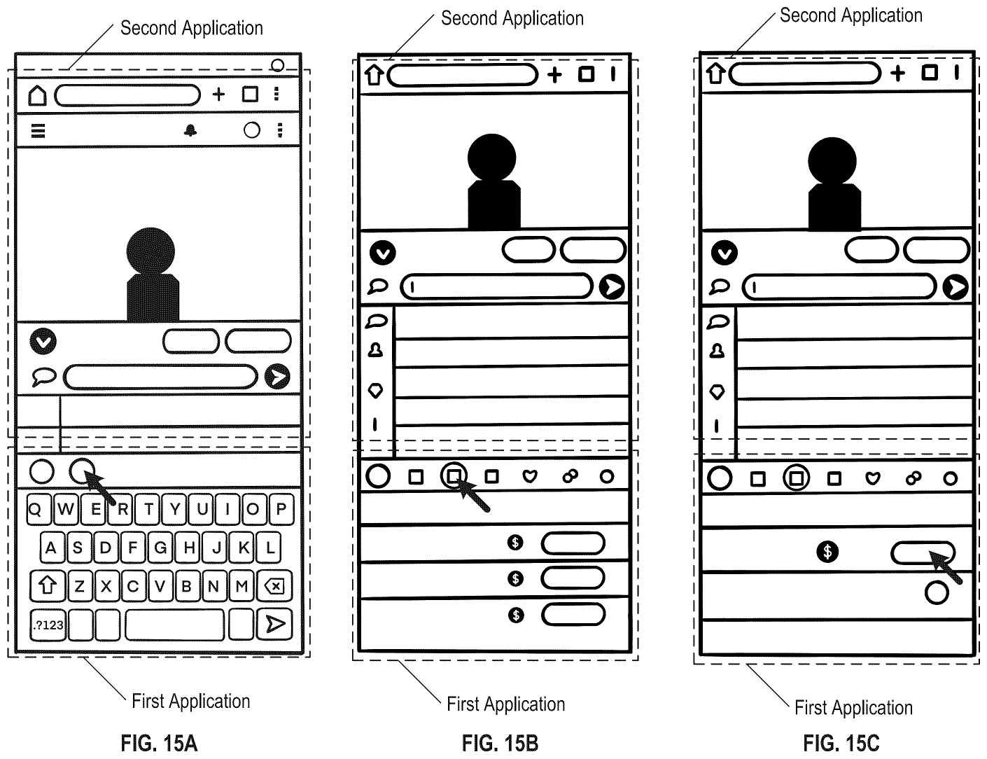

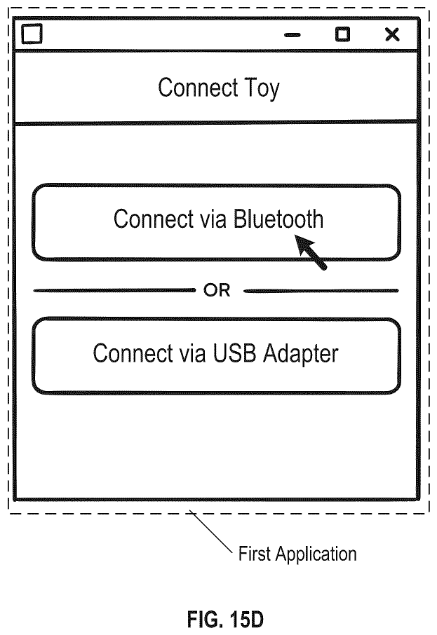

In some implementations, as shown in FIGS. 14 to 15C, when both applications are operated and displayed side-by-side on the first viewer device, the first application may provide at least one of a display function, a control function, or an interaction function with the second application. The display function allows the first application to display contents, such as interactive elements, on the screen. The control function allows the viewer or the streamer to perform certain operations, such as using the interactive elements to trigger a tipping action. The interaction function with the second application allows cross-application control between the first and second applications, as described herein. When only the first application is run, the first application may be used to configure at least one of the display function, the control function, or the interaction function with the second application, meaning that the first application itself can display or control the contents, or the first application itself can direct what contents to be displayed or controlled by the first viewer device, or to be interacted with the second application when it is run. In some implementations, the displayed contents may include information related to the status of the streamer (e.g., online with streaming, online without streaming, offline, etc.). The streamer could be followed by a user of the first viewer device. Therefore, when the streamer starts to stream online, the first application can notify the viewer so that the viewer may control an operation on the first application (e.g., clicking on the profile of the streamer) to turn on streaming via the second application, thus achieving interaction between the two applications.

In some implementations, the first application may act as an administrator for the second application, enabling it to control and manage various aspects of the second application's functionality. For instance, the first application can enable, disable, or modify features of the second application or contents being displayed on the screen. The first application may send a command to the second application to enable or disable these features. In some implementations, the first application may monitor and optimize the performance of the second application. For example, the first application may display a timer showing the duration of the live stream on the second application. This helps the streamer or the viewer track the length of the broadcast and the remaining duration of the accessory's operation. In another example, the first application may display the total amount of tips received by the streamer during the current live stream or for the day. This allows the streamer to monitor their earnings and acknowledge tippers during the broadcast.

Consistent with the embodiments of the present disclosure, the first application may be an input method application, a floating window application, or a mobile assistant application. For instance, as shown in FIG. 15A, the first application is an input method application with a keyboard shape, which is positioned below the second application on the screen and displays a streamer in the broadcast room of the online platform. In this example, the first application and the second application are operated and displayed simultaneously on the first viewer device (e.g., the mobile phone of the first viewer). After clicking through the tabs of the keyboard input method application, as shown in FIGS. 15B and 15C, it may further display various buttons, including the tipping buttons, enabling the user to seamlessly switch from a standard input interface to a stream control interface using the same space on the screen. In addition, as shown in FIG. 15D, the user may further use the first application to connect to another accessory via Bluetooth, Wi-Fi, USB adapter, etc., so that the viewer device may receive instructions from or send instructions to the accessory. Also, the use of the input method application as the first application not only makes it easy for the viewer to interact with the streamer, but also eliminates the anxiety of switching between different applications (such as the streaming application and the input application) when participating in the broadcast.

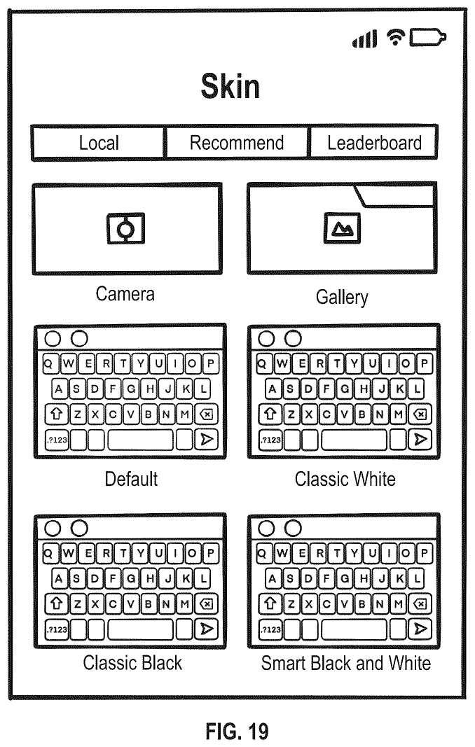

In addition, when the first application is an input method application, as shown in FIG. 19, it may employ a main program configured to provide background control and administrator functionality for the input method application, a display program configured to render a user interface (such as a keyboard as illustrated) for the input method application, and a display interface configured to present configuration options or contents associated with the input method application.

In some implementations, when the first application is an input method application with a keyboard interface, as shown in FIG. 19, the user may perform tipping via the keyboard. In one example, the first application may determine the preset location of the original tipping button (e.g., a button labeled “donate,” “tip,” “subscribe,” or with a specified number of tips, etc.) displayed on the screen, and then generate a simulated button (e.g., a tipping control button) corresponding to the original tipping button on the online platform. The viewers may tip the streamer by clicking the simulated button displayed on the keyboard of the first application, thereby performing the tipping operation on the first application without requiring interaction with the original tipping button. This configuration reduces operational steps required by the viewer.

In another example, the first application may first access an API of the online platform, where the API may include the functional modules for tipping. Then the first application may integrate the API into itself to establish communication between the keyboard of the first application and the online platform. Next, the first application may configure a tipping control on the keyboard to directly perform a tipping operation on the first application via the API, thereby enabling direct tipping by the viewer through the keyboard without additional user interaction or operation on the interface of the online platform.

It is noted that the method for implementing a tipping operation via a keyboard is not limited to the above implementations. The first application can also be configured to perform cross-system or cross-application access to at least one of the second application or the online platform. In that way, the first application is operable to interact with or control functionalities of other applications or system components to implement the tipping operation via the keyboard.

In some implementations, the interaction data transmitted from the first application performed by the viewer to the streamer accessory may include the frequency or number of clicks on an interactive button by a viewer via the first application. The vibration intensity or function behavior of the streamer accessory may be adjusted in response to the interaction data. For example, higher frequency or greater number of clicks on the interactive button by the viewer on the first application may result in a stronger vibration or increased activity of the streamer accessory. The interactive button may be mapped to a specific key on the keyboard, such as the “a” key on the keyboard. In some implementations, a feedback mechanism may be provided to the viewer with visual or auditory confirmation of the accessory's response to the interaction data via the first application. In some implementations, the intensity or behavior of the toy is dynamically adjusted in real-time based on the continuity of the input from the interactive button by the viewer. In some implementations, the interactive button is customizable to allow the viewer to assign specific keys or combinations of keys for controlling the streamer accessory.

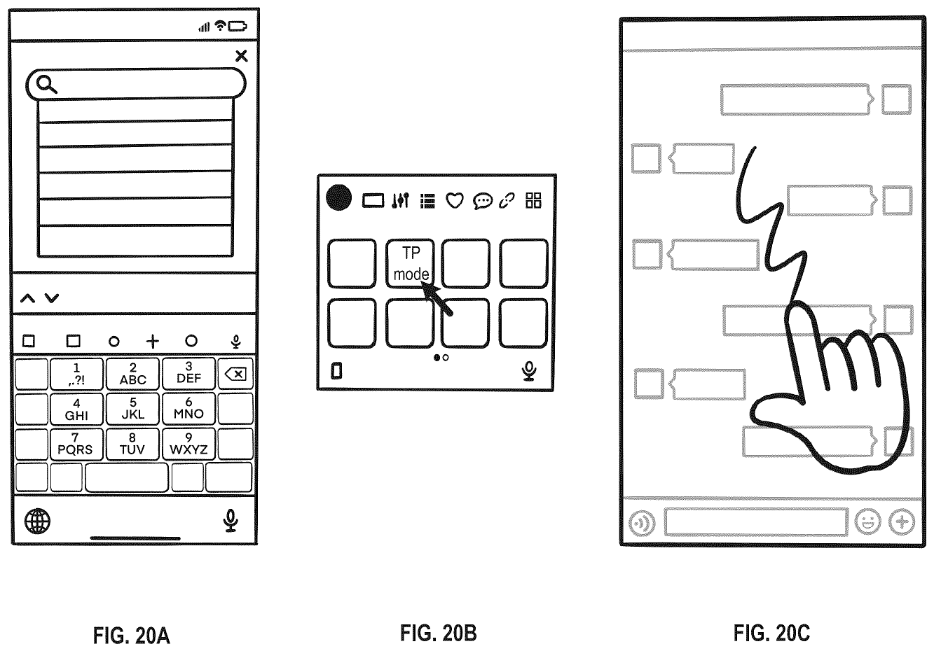

In some implementations where the input method application is used, the user may invoke a transparent mode of the first application through one or more simple touches, as shown in FIGS. 20A to 20C. This allows the viewer to perform operations on the first application (e.g., controlling the streamer accessory by making strokes on the screen) while simultaneously viewing the streamer's broadcast room on the online platform displayed on the second application. For example, as shown in FIG. 20A, the first application can be an input method application. After clicking a tab on the input method application, a series of buttons, including a button labeled “TP mode” (short for “transparent mode”), are shown. Next, after clicking on the TP mode, the interface of the first screen becomes a substantially transparent, screen-sized control panel for handwriting input. This transparent control panel of the first application overlaps with the display of the second application (e.g., the first application is overlaid on the second application) without substantially obstructing the contents displayed on the interactive interface of the second application. The viewer can view both the control panel and the contents displayed by the second application underneath. This allows the viewer to watch online entertainment contents (e.g., a live stream, video, or interactive show) on their device, while at the same time, controlling an accessory (e.g., a connected toy) without interrupting their viewing experience.

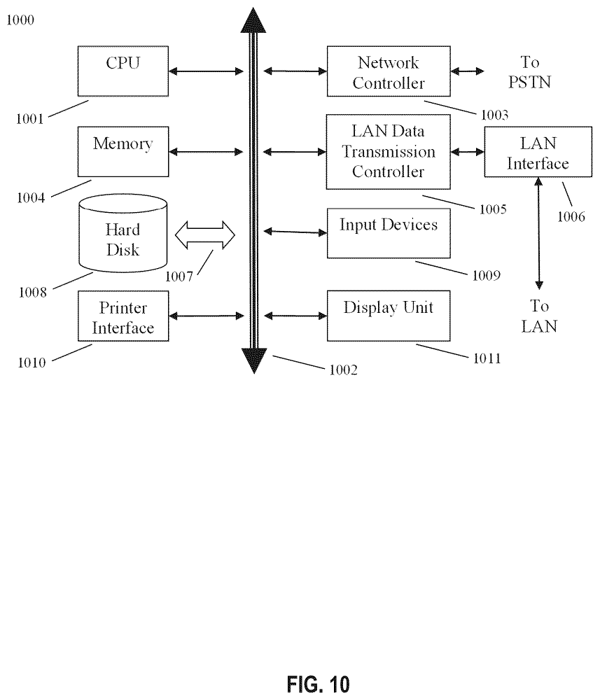

FIG. 10 shows an example of a computer system which may implement a method and system of the present disclosure. The system and method of the present disclosure may be implemented in the form of a software application running on a computer system, for example, a smartphone, a server, and/or a personal computer (PC), etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for participating in an interactive broadcast, performed by a first viewer device, comprising:
running a first application on the first viewer device;
accessing, via the first application, online entertainment data associated with an online platform, wherein the online entertainment data is accessible by at least one of:
a second viewer device configured not to run the first application, or
a third viewer device configured to run the first application; and
in response to trigger data received by the first application, generating a first instruction to control an operation of an interactive element based on the trigger data,
wherein the first application is configured to initiate the operation of the interactive element, and
wherein the operation of the interactive element is observable to at least one of the first viewer device or the third viewer device, but not observable to the second viewer device.

2. The method of claim 1, wherein before generating a first operation instruction to control an operation of an interactive element based on the trigger data, the method further comprises:
monitoring the trigger data, wherein the trigger data comprises data indicating at least one of an access permission of the first viewer device, or an operation instruction initiated by at least one of the first viewer device or a viewer accessory coupled to the first viewer device.

3. The method of claim 1, wherein the online entertainment data is hosted by a platform server associated with the online platform, and
wherein accessing, via the first application, online entertainment data associated with an online platform comprises:
retrieving, via the first application and through a first preset path, the online entertainment data from the platform server.

4. The method of claim 1, wherein at least a portion of the online entertainment data is hosted by a provider server associated with a provider of the first application, and
wherein accessing, via the first application, online entertainment data associated with an online platform comprises:
retrieving, via the first application and through a second preset path, the online entertainment data from the provider server.

5. The method of claim 4, wherein the provider server is configured to store information of a broadcast room from the online platform, and the first application is configured to retrieve the online entertainment data by accessing the stored information of the broadcast room.

6. The method of claim 1, wherein the interactive element comprises a first element associated with a second application, and wherein the method further comprises:
in response to the trigger data received by the first application, generating a second instruction to control an operation of the first element on the second application.

7. The method of claim 6, wherein controlling the operation of the interactive element based on the triggered data comprises at least one of the following:
displaying a tipping condition for a broadcast room of the online platform;
triggering a tipping action for the broadcast room of the online platform;
controlling an operation of a viewer accessory coupled to the first viewer device, with the controlling being displayed along with the broadcast room;
controlling an operation of a streamer accessory coupled to a streamer device, with the controlling being displayed along with the broadcast room;
accessing a Uniform Resource Locator (URL) and displaying a page corresponding to the URL on the first application;
modifying contents displayed on an interactive interface of the second application; or
displaying push information.

8. The method of claim 1, wherein streamed contents from the online platform are configured to be displayed by a second application, and
wherein the contents of the first application and the streamed contents of the second application are simultaneously displayed on the first viewer device.

9. The method of claim 8, wherein, in response to an operation input on the first viewer device, the first application is initiated, and
wherein the contents of the first application are displayed along with the streamed contents of the second application in an interactive interface to allow cross-application control between the first and second applications.

10. The method of claim 8, wherein, when the streamed contents of the second application are broadcast to the first viewer device, the contents of the first application are displayed without substantially obstructing the streamed contents of the second application.

11. The method of claim 8, wherein the contents of the first application are displayed independently from an interactive interface displaying the streamed contents of the second application.

12. The method of claim 8, wherein the contents of the first application are displayed as an embedded control panel within an interactive interface of the second application.

13. The method of claim 8, wherein, when both the first and second applications are run, the first application is configured to provide at least one of a display function, a control function, or an interaction function with the second application, or
wherein, when only the first application is run, the first application is configured to configure at least one of the display function, the control function, or the interaction function with the second application.

14. The method of claim 8, wherein the first application comprises a configuration program and a display program, the configuration program is configured to configure and modify displayed information, and the display program is configured to display the displayed information without obstructing the streamed contents displayed on the interactive interface of the second application.

15. The method of claim 8, wherein the first application is a software component integrated into the second application, and
wherein the software component comprises at least one of a plugin, a Software Development Kit (SDK), or an Application Programming Interface (API).

16. The method of claim 8, wherein, when the streamed contents are displayed on the second application, the first application operates independently from the second application and further comprises at least one of:
an input method application;
a floating window application; or
a mobile assistant application.

17. The method of claim 1, wherein accessing, via the first application, online entertainment data associated with an online platform comprises at least one of the following:
accessing page information of a broadcast room from the online platform via the first application, and retrieving corresponding online entertainment data of the broadcast room via the page information;
retrieving the online entertainment data of the broadcast room from the online platform via the first application through a preset interface of the online platform; or
performing image recognition on the broadcast room of the online platform via the first application, and retrieving the corresponding online entertainment data of the broadcast room.

18. The method of claim 1, wherein the first application is an input method application with at least one control button configured to be customized by a user of the first viewer device.

19. A first viewer device, comprising:
a memory storing computer-readable instructions; and
a processor coupled to the memory and configured to execute the computer-readable instructions, wherein the computer-readable instructions, when executed by the processor, cause the processor to perform operations comprising:
running a first application on the first viewer device;
accessing, via the first application, online entertainment data associated with an online platform, wherein the online entertainment data is accessible by at least one of:
a second viewer device configured not to run the first application, or
a third viewer device configured to run the first application; and
in response to trigger data received by the first application, generating a first instruction to control an operation of an interactive element based on the trigger data,
wherein the first application is configured to initiate the operation of the interactive element, and
wherein the operation of the interactive element is observable to at least one of the first viewer device or the third viewer device, but not observable to the second viewer device.

20. A non-transitory computer-readable medium storing instructions that, when executed by a processor of a first viewer device, cause the processor to perform operations comprising:
running a first application on the first viewer device;
accessing, via the first application, online entertainment data associated with an online platform, wherein the online entertainment data is accessible by at least one of:
a second viewer device configured not to run the first application, or
a third viewer device configured to run the first application; and
in response to trigger data received by the first application, generating a first instruction to control an operation of an interactive element based on the trigger data,
wherein the first application is configured to initiate the operation of the interactive element, and
wherein the operation of the interactive element is observable to at least one of the first viewer device or the third viewer device, but not observable to the second viewer device on the online platform.
